(19) United States
(12) Patent Application Publication
(10) Pub. No.: US 2004/0012177 A1
(43) Pub. Date: Jan. 22, 2004

(54) Airbag module with elastic mounting of the gas generator

(75) Inventor: Frank Sauer, Niedernberg (DE)

Correspondence Address: FOLEY AND LARDNER, SUITE 500, 3000 K STREET NW, WASHINGTON, DC, 20007, US

(73) Assignee: TAKATA-PETRI AG

(21) Appl. No.: 10/436,370

(22) Filed: May 13, 2003

(30) Foreign Application Priority Data
May 16, 2002 (DE) 102 22 772.1
Jul. 1, 2002 (DE) 202 10 372.2

(51) Int. Cl. B60R 21/16

(52) U.S. Cl. 280/731

(57) ABSTRACT

An airbag module with elastic mounting of the gas generator, in particular for steering wheels. The module includes at least one electrically conductive, elastic mass element for the elastic mounting thereby eliminating the requirement for additional grounding of the gas generator. The electrically conductive, elastic mass element may comprise electrically conductive elastomers. For example, it may comprise electrically conductive silicone or electrically conductive rubber.

### BACKGROUND OF THE INVENTION

The invention relates to an airbag module with elastic mounting of the gas generator.

Airbag modules with elastically mounted gas generators are preferably provided in steering wheels in order to reduce the tendency of the steering wheel to vibrate. The elastic mounting of the gas generator has the effect of decoupling vibrations with respect to the steering wheel. Appropriate dimensioning of the gas generator or of the spring elements also makes possible the use thereof as a vibration absorber.

In addition to airbag modules, in which elastic bushings are provided in the region of the fastening screws of the gas generator (see e.g., EP 1 020 332 incorporated by reference herein), an airbag module is known, in which the gas generator is held by elastic elements without screw connections being provided in the region of said elements (see e.g., DE 201 08 594 U1 incorporated by reference herein). In the case of this airbag module, the elastic element which is provided is a hollow profile with a closed cross section and with a circumferential wall, the radial outside of which bears, on one side, against the gas generator and, on the other side, against a holding part on the module.

In these airbag modules with elastically mounted gas generators there is no metallic connection between the gas generator and the vehicle. The gas generator therefore has to be additionally grounded. This additional grounding can be undertaken via a flexible cable. This produces disadvantages. This cable does, of course, lie outside the airbag unit giving rise to safety problems in respect of the installation and transportation of the airbag unit. During these activities the cable may become detached or automatic triggering of the airbag unit may occur. Furthermore, the vibrating gas generator likewise causes this cable to vibrate. At the same time the cable must not come into contact with anything.

### SUMMARY OF THE INVENTION

The invention is therefore based on the object of avoiding additional work for grounding the gas generator and malfunctions in the airbag unit in the case of airbag modules with elastically mounted gas generators.

In the case of an airbag module with elastic mounting of the gas generator, in particular for steering wheels, the invention provides at least one electrically conductive, elastic mass element for the elastic mounting. A mass element is understood to be a compact element, but not spring elements, such as, for example, helical springs or spiral springs, which are produced from wire-shaped material.

The advantage of a mounting of this type is that no additional grounding of the gas generator has to take place and that additional cables and additional installation work associated therewith can therefore be omitted.

The electrically conductive, elastic mass element may consist of electrically conductive elastomers. In particular, it consists of electrically conductive silicone or electrically conductive rubber.

The electrically conductive, elastic mass element is arranged between the gas generator and a metallic subassembly connected to the motor vehicle. It is expedient for the electrically conductive, elastic mass element to be arranged between a flange on the gas generator and a vibration-absorbing plate. In one embodiment, the elastic mass element is cup-shaped, with the base of the cup lying at the top and being connected to the flange of the gas generator, and with the cup having, on the outside in the lower section, a projection for the connection to the vibration-absorbing plate. It is expedient for the vibration-absorbing plate to be angled upwards in the region of the projection and for this angled section to be connected to the projection of the cup. For the connection between the gas generator and the vibration-absorbing plate, the electrically conductive, elastic mass element can be vulcanized onto the vibration-absorbing plate and connected to the flange by at least one rivet.

In a first embodiment, a plurality of electrically conductive, elastic mass elements are arranged at the same angular distance from one another. It is expedient to provide at least three electrically conductive, elastic mass elements.

However, it is also possible for the electrically conductive, elastic mass element to annularly surround the gas generator.

In a further embodiment, provision is made for the electrically conductive, elastically deformable mass element to be slotted in. The mass element can preferably be slotted into the flange connected to the gas generator and into the vibration-absorbing plate. The mass element preferably has grooves to enable it to slot in, with the parts to be connected engaging in said grooves.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 shows a section through an airbag module of a steering wheel;

FIG. 2 shows the detail E according to FIG. 1;

FIG. 3 shows a detail which, in place of the design in the detail E, shows a design with an electrically conductive, elastic mass element which can be slotted in.

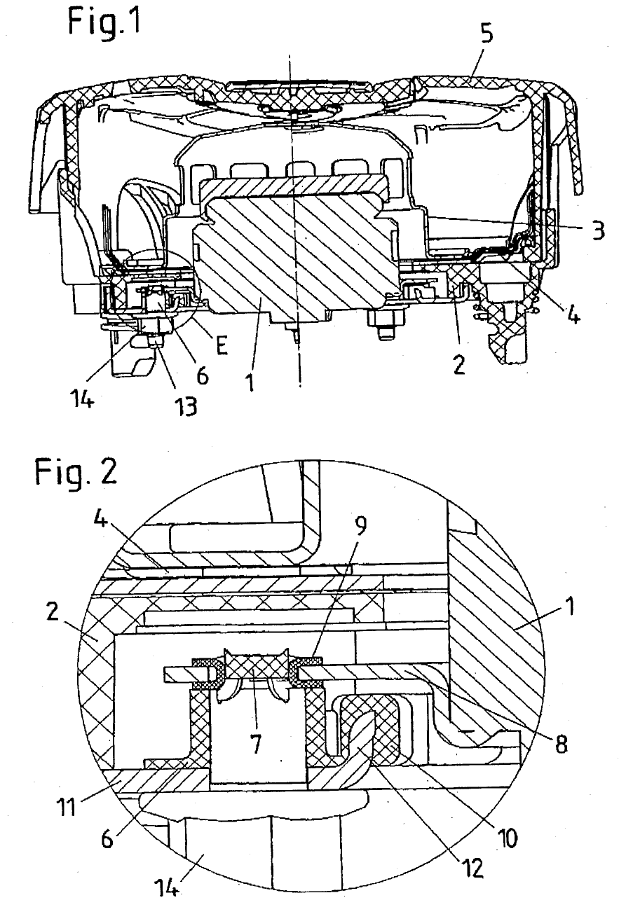

### DETAILED DESCRIPTION

The airbag module has a gas generator 1, a generator carrier 2, a diffuser 3, an airbag 4 and a cover 5. Three electrically conductive, elastic mass elements 6 which are arranged at the same angular distance from one another are provided for the elastic mounting of the gas generator 1. The mass elements 6 have a cup shape, with the base 7 of the cup lying at the top. The mass elements 6 consist of silicone or rubber. On the gas generator 1, flanges 8 are provided in the region of the mass elements 6 and are connected to the mass elements 6 by rivets 9.

Each cup-shaped mass element 6 has a projection 10 on the outside, in the lower section. Furthermore, vibration-absorbing plates 11 which are angled in the region of the projections 10 are provided on the generator support 2 in the region of the mass elements 6. The cup-shaped Mass elements 6 are connected to the vibration-absorbing plates 11 by vulcanization, with the projections 10 surrounding the angled section 12. The vibration-absorbing plates 11 are connected to a metal part (not illustrated) of a steering wheel by screws 13 and nuts 14.

In this arrangement, an electrically conductive connection of the gas generator 1 to a metal part of the steering wheel, and hence to the vehicle, is produced via the flanges 8, the rivets 9, the electrically conductive, elastic mass elements 6, the vibration-absorbing plates 11 and also via the screws 13 and nuts 14, and it is therefore ensured that the gas generator is grounded.

Instead of the mass elements 6 which are arranged at the same angular distance from one another, it is also possible for a single mass element also to annularly surround the gas generator. In this case, it is advantageous also to provide an annular flange on the gas generator. This embodiment has not been illustrated separately, since the section of FIG. 2 essentially also corresponds to the section of this further embodiment.

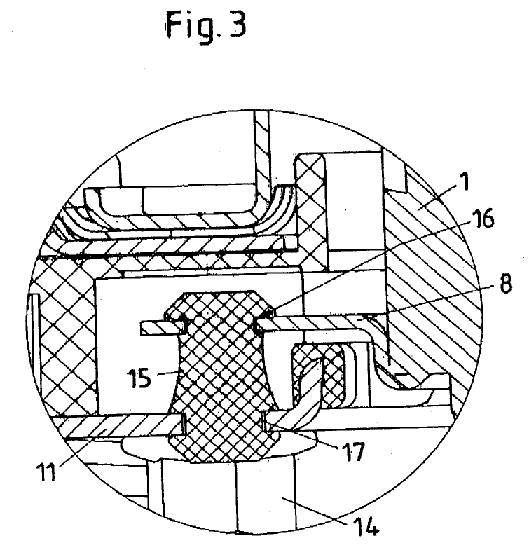

In the case of the embodiment of FIG. 3, an electrically conductive, elastic mass element 15 which can be slotted in is provided. Said mass element has an encircling groove 16 for the slotting in of the flange 8 which, as in the previously described embodiment, is connected to the gas generator 1. Furthermore, the mass element 15 has an encircling groove 17 which is provided for the slotting in of the vibration-absorbing plate 11. In this case, the grooves are designed to be of such a width and such a depth that the parts 8 and 11 are in close contact with the mass element 15 over an extensive area, with the result that the electric connection is also ensured in this embodiment.

The priority applications, German Patent Applications DE 102 22 772.1 and DE 202 10 372.2, filed May 16, 2002 and Jul. 1, 2002, respectively, are incorporated by reference herein in their entireties.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag module with elastic mounting of a gas generator, in particular for steering wheels, wherein at least one electrically conductive, elastic mass element is provided for the elastic mounting.

2. The airbag module of claim 1, wherein the mass element consists of electrically conductive silicone or electrically conductive rubber.

3. The airbag module of claim 1, wherein the mass element is arranged between the gas generator and a metallic subassembly connected to the motor vehicle.

4. The airbag module of claim 1, wherein the mass element is arranged between a flange on the gas generator and a vibration-absorbing plate.

5. The airbag module of claim 4, wherein the mass element is cup-shaped, with the base of the cup facing upward and being connected to the flange of the gas generator.

6. The airbag module of claim 5, wherein the cup-shaped mass element includes on the outside in a lower section, a projection for the connection to the vibration-absorbing plate.

7. he airbag module of claim 6, wherein the vibration-absorbing plate is angled in the region of the projection and in that this angled section is connected to the projection of the cup-shaped mass element.

8. The airbag module of claim 4, wherein the mass element is vulcanized onto the vibration-absorbing plate and is connected to the flange by at least one rivet.

9. The airbag module of claim 1, wherein a plurality of mass elements are arranged at the same angular distance from one another.

10. The airbag module of claim 1, wherein the mass element annularly surrounds the gas generator.

11. The airbag module of claim 10, wherein the mass element can be slotted into the flange connected to the gas generator and into the vibration-absorbing plate.

12. The airbag module of claim 11, wherein the mass element has grooves for connecting to the flange and to the plate.
